(19) United States
(12) Patent Application Publication
(10) Pub. No.: US 2008/0046924 A1
(43) Pub. Date: Feb. 21, 2008

(54) SYSTEM AND METHODS FOR COMPETITIVE DYNAMIC SELECTION OF DIGITAL ADVERTISING ASSETS IN A VIDEO DISTRIBUTION SYSTEM

(75) Inventor: William E. Hood, Marietta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TANDBERG TELEVISION INC., Duluth, GA (US)

(21) Appl. No.: 11/460,832

(22) Filed: Jul. 28, 2006

(51) Int. Cl. H04N 7/10; H04N 7/025

(52) U.S. Cl. 725/36; 725/32

(57) ABSTRACT

Systems and methods for an advertising auctioning capability are disclosed in conjunction with viewing of a movie or other type of program asset in a video distribution system. At certain points of the movie, called avails, advertisements are presented to the viewer. Each advertisement is selected from a plurality of advertisements based on criteria defined for selection. The selection of the advertisements may be based on criteria defined by the auctioning campaign, by the movie, the advertisements, and demographic information of the viewer selecting the movies. The auctioning process can occur in real-time and in various components, including a video on demand server or the viewer's set-top-box. Various tools are disclosed for indicating the avails, and defining the criteria for conduction the advertising auction campaign.

### FIELD OF THE INVENTION

The present invention generally pertains to the dynamic selection of one of several competing digital advertisements for insertion into a video stream for presentation to a viewer associated with a cable television system.

### BACKGROUND

The incorporation of advertisements between, and during, video programs is well known. Typically, one or more advertisements (e.g. commercials) are interspersed in a video program, as well as between programs. Historically, the selection of the commercial was accomplished at a predefined location and in a manual manner. The location was typically the source of the programming. Thus, for a nationally broadcasted program, the originator of the program would arrange for the selection and insertion of the commercials. Thereafter, the recipient of the broadcast received the signals which conveyed the program and signals.

Obviously, this scheme results in a large number of audience members viewing the same advertisement, and thus, the advertisement had to be designed for broad viewer appeal. In another variation of the scheme, certain timeslots or programs were designated for local broadcasters to select and insert advertisements, thereby allowing commercials of a more local nature to be provided. This provided the ability to define national or local based advertisements. Obviously, the commercial's effectiveness is based on the targeted viewing audience. Thus, for a national program, a national-based commercial may be aired (e.g., a commercial for an automobile manufacturer). In a local inserted advertisement, a particular auto dealership may be advertised. Obviously, providing a locally based commercial for a particular local auto dealership would have limited appeal to viewers of the program in another state or another part of the country.

In addition, studies have shown that advertising targeting certain groups can be more effective in achieving certain goals. Thus, commercials can be designed for certain demographic groups, or other groups having certain characteristics. The challenge has been to be able to select the appropriate advertising for the targeted group based on the particular medium being used. The correlation of the type of advertisement is thus tied to the particular target audience of the medium conveying the advertisement.

In modern video systems conveying digital programs, (such digital programs are often referred to using the generic term “digital asset”), the selection and ‘insertion’ of an advertisement (another form of a digital asset) can occur at various points along the distribution of the program video asset. The distribution of the program video asset can be analogized to a tree structure, with the root corresponding to the program source and the tips of the branches corresponding to the actual viewers. The trend is to select and insert the advertisement as far as possible into the tree structure, near the tips of the branches. Because the demographics of an individual household is very granular and specific, this allows commercials to be closely targeted to the viewer's interests. In addition to moving the advertisement insertion point closer to the tips of the branches for finer geographic and demographic granularity, there is also a trend to defer the insertion time as late as possible to enhance the advertising targeting. In traditional systems the decision for ad placements would be made weeks or months in advance, where ideally the decision would be made in real-time just before the ad is actually viewed.

Current technology exists for allowing the dynamic selection and insertion of digital assets (e.g., commercials) at various points along the distribution of a program digital asset. Further information can be found in U.S. Patent Application 2002/0143976, entitle Method and System for Managing and Updating Metadata associated with Digital Assets, filed Mar. 7, 2002, and U.S. Appl. No. 2004/0025181, entitled System and Method for Capturing Broadcast Assets for On-Demand Viewing; filed Nov. 12, 2002, the contents of which of both applications are incorporated by reference into the present application.

At a high level, a digital asset, such as a program, is labeled using digital markers at certain points during the program (called “avails”) as to where advertisements can be inserted or replaced. Although this can be logically viewed as a marker inserted at a certain location in the digital program stream, the avail may be actually conveyed by providing data separate from the MPEG file (typically the avail-related data is associated with the corresponding asset metadata) indicating a point in time which an advertisement may be inserted. This process involves a person using a workstation, and a specialized editing tool to provide these digital markers. An advertisement may be inserted or referenced, and the asset is repackaged and distributed with the program. Thus, in one embodiment, a separate MPEG file is produced which has the inserted advertising assets. At various points during the distribution, additional avails can be added, existing advertisements can be replaced or removed, or new advertisements added.

These processes can also occur in real-time, ‘on-the-fly.’ That is, a spooling MPEG program is ‘held’ or buffered while a particular advertising asset is selected and spooled out. The insertion can be accomplished by creating a library of available commercials in a database that are selected and retrieved in real-time to replace an existing advertisement. This requires advertisements to be mapped to certain types of programs so that appropriate automated selection can occur. By defining meta-data (information about a given asset, such as a program or advertisement), selective targeting of the advertisement with an appropriate program can be accomplished. Thus, certain advertisements for products that are targeted for adults, such as pharmaceuticals, are not selected for inclusion for children's television programs, such as cartoons. Rather, only commercials targeted for children's programs are selected and inserted.

The existing systems for inserting ads into broadcasts are not flexible, and the scope is limited to either national or local. In addition, the decision of which ads to place in which content is typically made a day or more in advance. Finer levels of targeting are not possible. Therefore, there is a need for a system and methods of providing a more flexible approach to selecting and inserting advertising in digital assets that are distributed to viewers.

### BRIEF DESCRIPTION OF THE SEVERAL VIEWS OF THE DRAWING(S)

Reference will now be made to the accompanying drawings, which are not necessarily drawn to scale, and wherein:

FIGS. 1a and 1b illustrate the prior art of selection and insertion of advertisements in a cable system.

FIG. 2 illustrates one embodiment of components for selecting and inserting an advertisement.

FIG. 3 illustrates another embodiment of a VOD system for selecting and inserting an advertisement.

FIG. 4 illustrates another embodiment of a set-top-box server for selecting and inserting an advertisement.

FIG. 5 illustrates a process/system flow for one embodiment for enabling the auctioning of advertisements.

FIGS. 6a-6g illustrate various embodiments for defining an advertisement auction campaign.

FIG. 7 illustrates one embodiment of the logic flow for auctioning various advertisements.

FIG. 8 illustrates another embodiment of the logic flow for auctioning various advertisements.

### DETAILED DESCRIPTION OF THE INVENTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. For example, although the term “cable system” is used throughout, this term, as well as “digital video asset distribution system” is intended to cover various forms of digitized video distribution and technologies, including wireless (including satellite distribution) and other technologies (e.g., fiber, IP based, etc).

In addition, as used herein, the term set top box (STB) can refer to a conventional STB, including those with digital video recorder capability operating in conjunction with various types of televisions or display devices. Further, high definition STBs, satellite based receivers, media center personal computers, video hubs, etc could also perform the functionality of a STB, either individually or in conjunction with other equipment. The functionality of a STB could be embodied in other non-traditional video devices, such as mobile telephones, personal video playback devices, personal digital assistants, and other similar devices (or combinations of such devices functioning together). All of these are potential embodiments of equivalents to the STB.

Overview

The present invention provides for the competitive selection and insertion of advertising assets into a video program. The invention may apply to any of the various video distributions systems, such as those found in cable television systems, video on demand, satellite video distribution systems, broadcast television, or other distribution systems or technologies associated with video distribution commonly in current use. Further, the programs may be broadcast programs, video on demand programs, programs that are played back from a digital video recorder (DVR) service, or in general, any multimedia experience which involves targeted advertising content. The application of the present invention is not limited with respect to the type of programming, the type of advertising, the type of video distribution system, etc. Any video program, any video distribution architecture, and any video advertisement can benefit from the principles of the present invention.

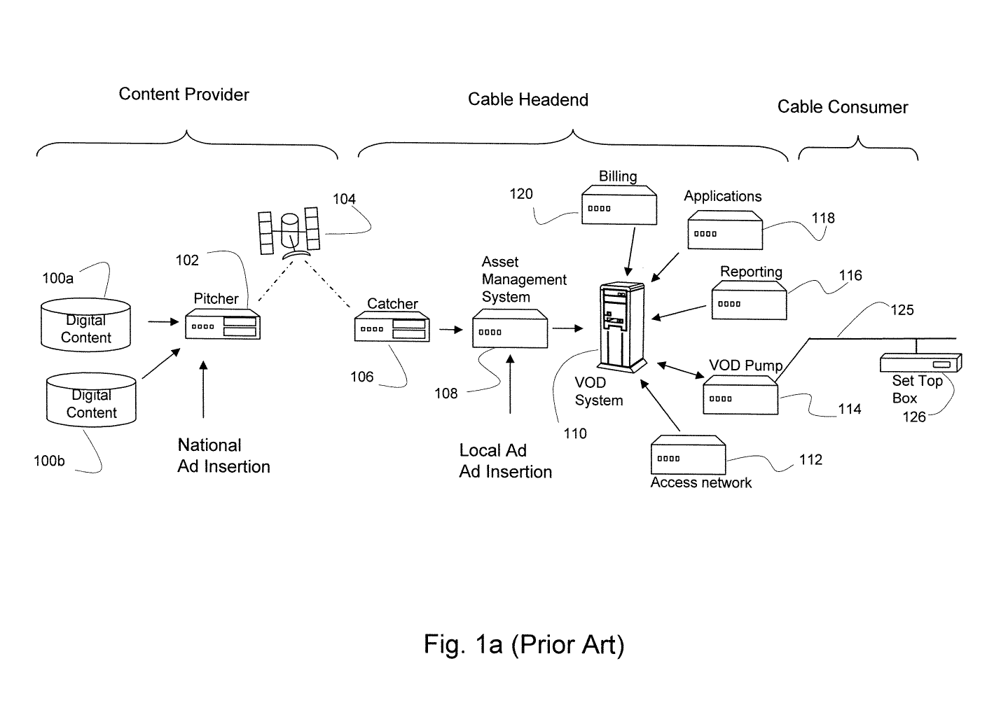

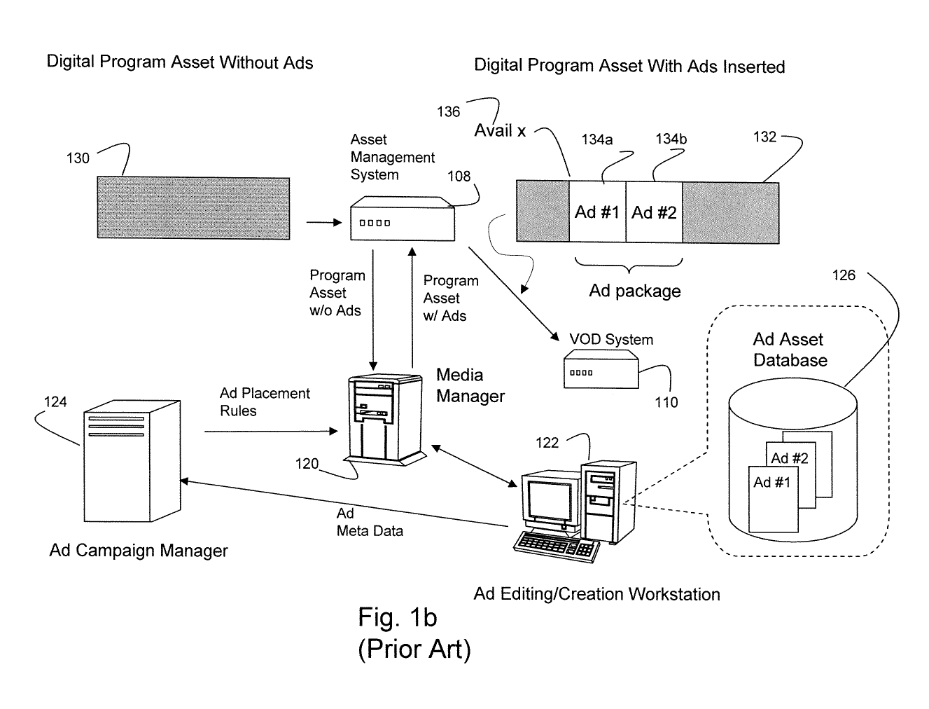

A typical architecture for inserting and distributing digital advertising assets in a VOD (Video-On Demand) digital movie asset, for example, is shown in FIG. 1a. The term “digital video asset” applies to any type of digital video data file, whether it be a movie, program, advertisement, game, program guide information, barker channel, Interactive TV application, or other application. A particular form of a digital video asset could be a digital movie asset, which refers digital video data file comprising a movie (for example, a video-on-demand selected movie). A digital advertisement asset is one form of a digital video asset which may comprise an advertisement, and may be a simple digital video data file with associated metadata or may be a Long Form Ad, Telescoping Ad, Interactive TV application, Barker Ad, Banner Ad, etc. In FIG. 1a, digital content is stored in a database 100a, 100b which can be loaded into a “pitcher” 102 for uploading content to a satellite 104. Prior to distribution to the local VOD sites, national advertising may be inserted into the digital video asset by a national media manager. Once the program asset with the inserted advertisement is relayed by the satellite, it is received by a component called a “catcher” 106. Ads may be inserted into a MPEG file at any point upstream of the VOD system, so national ads may be inserted by the national media manager and local ads may be inserted (or might override national ads) by a local media manager. The MPEG content and the advertisements are integrated into one file and that particular combination of content and advertisements is sent downstream.

The digital asset is received and then stored in an asset management system 108 (AMS). The AMS may store the asset until it is needed, when it is transferred to a VOD system 110 that can store the program asset in a VOD library for distribution by the Video Pump 114 to the set top box 126, where is it can be viewed on a television.

When the asset is played out, it is handled by a VOD system and provided to a VOD pump which directs the stream to the cable network. In other embodiments, other types of video sources can be used. Rather than using a VOD pump, other video sources, such as a local file on a DVR, cable headend broadcast, satellite relayer, etc. could be used. The VOD system interacts with various other systems, including billing systems 120, software applications 118, and reporting systems 116.

The insertion or selection of an advertisement can occur further downstream. Although not shown, advertisements can be distributed for insertion to components downstream, including the set top box 126. For example, a set top box may be loaded with a set of advertisements and may locally process the avails associated with a program asset. Thus, the selection of the ads based on the selected movie may occur in the set top box.

The benefit of inserting advertisement downstream is that they may be more closely tailored to the demographics of the end users. Typically, the demographics of the viewing audience is smaller and can be defined in a more granular fashion. Thus, by pushing the ad inserting out to the set top box, the selection of an ad can be tailored to the demographics of the household.

FIG. 1b illustrates one prior art embodiment for inserting advertisements into a digital program asset. The advertisements are defined for a certain time period, and are static. Thus, program files for a given period (e.g., a day or week) are prepared and loaded. A new set of advertisements may be incorporated in the next period, but this is viewed as essentially a static selection and definition of ad insertion.

The local advertisement insertion process, for instance, begins when a program asset 130 is received by an asset management system. It may be received in different ways, but for purposes of illustration, it is assumed that no avails are defined and no national ads have been filled. The asset management system 108 functions as a switch and storage unit for the asset. It can provide the program asset without any avails to the media manager 120. The media manager 120 can be accessed via an asset editing and creation workstation 122 (“workstation”) that allows the avails' metadata to be defined. The workstation can also create (encode) locally stored assets 126. Similarly, advertisement assets can be received by an asset management system and forwarded to the local media manager.

The Ad Campaign Manager 124 can create rules for associating specific ads with certain avails for a given a program asset. The end result is that the media manager 120 is able to take the MPEG movie asset, combine the appropriate program and ads and distribute the resulting movie asset with the inserted ads to the Asset Management System. The Asset Management System, can then, for example, send it to the VOD system. Upon selecting a movie, the VOD System will spool the movie over the cable network to the user's set top box.

The movie asset 132 with the ads inserted is shown. An avail 136 is shown, but it is more for illustration purposes, since the actual ad asset 134a, 134b is inserted in the movie asset 132. The resulting integrated asset is provided to the VOD system and stored. As such, the ads for the movie asset are fixed, at least until a replaced version of the movie asset is provided.

Real Time Ad Auctions

As described above, movie content files are pre-combined with specific ads and stored in various network elements in a static manner. While it is possible to redefine the ads for a given movie, this occurs in the next update period. The selection of the ad is done ‘off-line’ and in advance. The definition may be based on a limited time period (e.g., for the next day, or week). For any given movie, the ads that are inserted in a movie are seen by all viewers serviced by a specific local site, and are static and determined for that time period. Thus, once defined, the advertisements associated with the movie are statically targeted for a specific viewing audience.

The ability to auction ads (a.k.a. “ad auctioning”) provides a mechanism for dynamically selecting which advertisement are to be inserted in conjunction with a specific viewing of a movie. The criteria for selection is akin to an auction and depends on the avail associated with the program, the criteria defined for each advertisement, and the logic for selecting a winning ‘bidder.’ Thus, it is possible to alter the chances of selecting a particular advertisement for a particular avail. This provides greater flexibility is targeting ads according to the circumstances, and is likely to results in more effective advertising results.

Unlike the prior art, where the decision is made off-line, not in real-time, and involves “editing” the advertisement into the digital asset, one embodiment of the present invention allows the decision of which advertisement to use be determined in real time. Further, the identification of the advertisement can occur at various points in the distribution network. The rules for selecting the advertisement are provided to any network element which is capable of conducting an auction according to certain rules, and after selecting an asset, the network element has ready access to the selected advertising asset allowing it to insert it in real time. In other embodiments, the selection of ads for an asset (such as a video-on-demand movie) are done in real time at the onset of the playing of the movie. Thus, once the movie is selected, all the avails are auctioned off to a set of advertisements, and once completed, the movie is played with the selected ads inserted. Thus, a viewer selecting the same movie at different times, or different viewers selecting the same movie at the same time, may encounter different advertisements.

In one embodiment, a VOD system may store advertisement assets, as well as the auction logic for selection and insertion of an advertisement. In another embodiment, the set top box may stores the advertisement assets and auction logic for insertion. It is feasible that in some embodiments, both network components could both perform an auction, which would allow a downstream element to potentially replace a previously inserted ad. In other embodiments, network-based components and viewer-premised-based components are involved in auctioning ads.

A network provider may define various rules as to how and when various elements interact. For example, the VOD system may select and insert ads for a given movie. In other instances, e.g., for local broadcasts, the local network provider may use a different element for selecting and inserting ads into broadcast assets. Still, for another type of service, the set-top-box may insert the ads. The barker channel (the channel showing a listing of programs, their times, and channels, and which has a window featuring continuous advertisements) could have its own auction process for providing certain viewers ads.

Advertisement selection logic may include the location and/or demographics of the viewer. For example, barker channel ads may be auctioned in the set top box, as they are designed to be targeted for that particular household. This requires knowing the demographics and location of the set top box. Since the cable provider knows the service address, mapping demographic information with the service address is readily possible. For other types of programs, e.g., linear local broadcast programs, other auction programs may be run for local based advertisements in another network element. Further, different bidding and auction logic can be used.

A network element performing an auction will have a program asset (which is marked with avails) and the potential advertising assets available. Further, it will have information about the program asset, information about the advertisements, and which types of program assets they are to be associated with. The network element will also have logic for conducting the auction, and rules associated with the auction. In addition, the network element may establish the context for the auction, including the device, customer, site, event time, and other data values associated with the specific auction event. The network element receives an event indication that causes it to trigger an auction. Upon identifying the movie asset with the associated avails, the network element executes an ‘auction’ to determine which ‘bid’ wins, wherein the bids are associated with each advertisement placement. The network element selects the advertisement to be inserted based on who is the winner of the auction. This introduces a real-time selection process of the ad based on various criteria and data defined the ad campaign. Again, this auction can occur just prior to the avail being encountered, or for a given program asset, just prior to its initial spooling. Further, the auction can be conducted for all the avails or a subset thereof, for a given program asset. Other variations are possible.

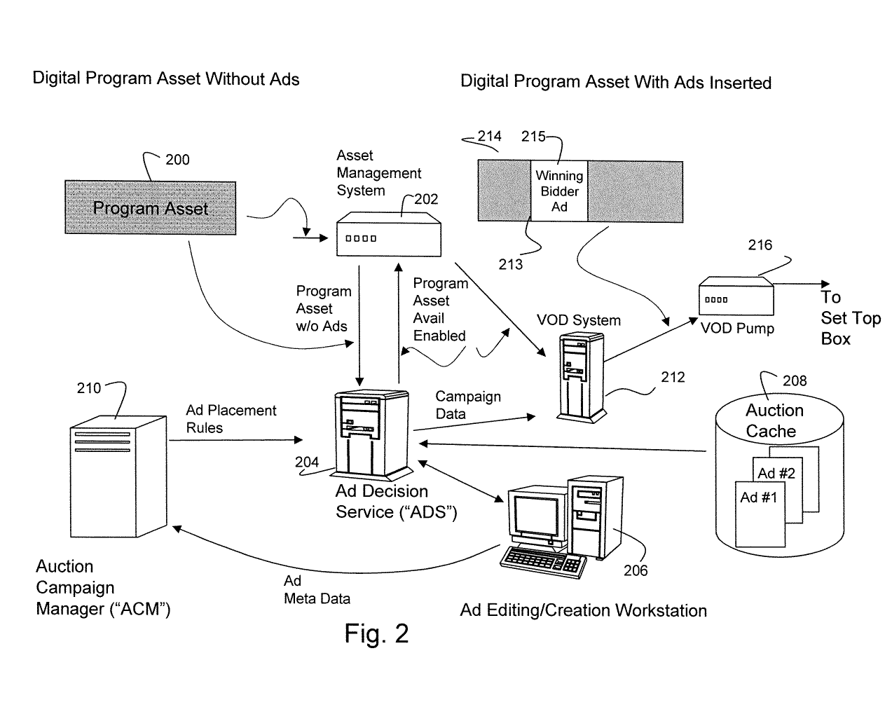

FIG. 2 illustrates one embodiment of the present invention in which the auctioning occurs in a VOD system. As it will be seen, the auction can occur in other elements, including, for example, the set top box. In FIG. 2, a program asset 200 is received by an Asset Management System 202. The program asset in this case is a movie that is going to be made available for VOD, and as such, is destined to be stored in the VOD system 212. Unlike the prior art, the movie asset is stored in the VOD system without the ads defined or inserted. The program asset 200 may or may not have avails initially defined, and may even have pre-existing advertisements inserted. For purposes of illustration, it is assumed the program asset has neither advertisements or avails defined. Thus, the first step is to define the avails.

Once the program asset is received by the asset management system 202, the cable operator may define the avails to indicate where the advertisements may be inserted if this has not already been defined in the program asset metadata. The asset management system interacts with the workstation 206 that allows the definition (called “marking”) of avails in the program asset. Once the avails are defined for the asset, the asset management system can distribute the program asset to the appropriate VOD system. In large networks, there may be numerous VOD systems which are geographically dispersed, and so that a given asset may be replicated with avails for auction in multiple VOD systems, with different auctioning criteria.

The auction campaign manager (“ACM”) 210 allows the creation and editing of all the aspects governing the execution of the auction campaign. This includes creating and controlling auction campaigns, and monitoring the progress of the auction campaign, etc. While an auction can be thought of as a specific instance of bidding for an avail, the auction typically involves multiple logically grouped bids referred to as auction campaigns. The creating of the auction campaign entails how long a group of advertisements will run, where they should be run, to whom they should be targeted, what type of movies the advertisement should it be linked to, etc. This may require the workstation to make available the meta-data regarding certain advertising assets to the ACM 210. The output of the auction campaign is a set of criteria (auction data) that will be used by the auction logic for selecting the advertisement. As the auction is performed in the Ad Decision Service (“ADS”) 204, the ACM providers the information to the ADS 204 which directs the placement of the auction data to the VOD system 212. The ACM 210 can also be used to define the type of auction, and other constraints, which are placed into the auctioning entity (in this embodiment, the ADS).

In this approach, the program asset and separate object data comprising the avails are stored in the ADS. The ADS also has access to the auction logic, and the meta-data regarding the advertisements in the database of the Auction Cache 208. In certain embodiments, the Auction Cache 208 may be integrated into the ADS, or otherwise made available to the VOD system by the being retrieved by the ADS and provided to the VOD system upon request.

Upon a viewer selecting a particular movie for viewing, the VOD system will prepare to spool out the asset. The demographics, location, or other information about the user is ascertained. This information is provided to the auction logic in the ADS, and the ADS will conduct the ad auction using the meta-data defining the selected program asset. Certain rules and criteria for selecting the appropriate ads are defined based on the context for conducting the auction. The auction occurs in real time, and as a result, the ADS selects the appropriate advertisement asset 208 from a database of advertisements for insertion. This may occur in real time, just prior to the program being spooled. The resulting digital asset 214 which has the winning advertisement 215. This is provided to the VOD System 212 which controls the distribution of the asset to the set top box via the VOD Pump 216.

The VOD system (or other components) in the system that receive the VOD request may associate the request with demographics-related information regarding the viewer making the selection. Specifically, information regarding the demographics of the viewer may be ascertained by mapping the request from the set top box to a subscriber profile, which may contain the demographic information. Other alternatives exist, such as using the subscriber identity or serving address to access other, third party databases for providing demographic information. This information may be passed to the ADS for consideration in selecting the possible candidate advertising assets or the winning bidder. Because there is significant variation in the criteria used in evaluating bids, or determining which advertisements can even bid for a given program asset, not all embodiments may necessarily use demographic or location information in evaluating the auction context.

Defining Auction Criteria

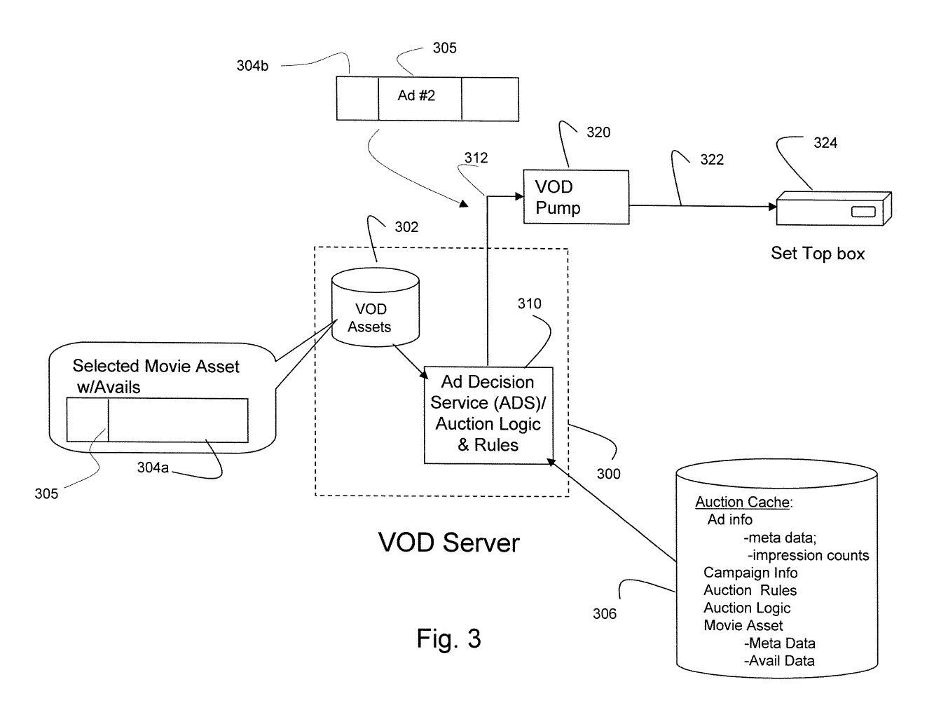

FIG. 3 focuses in greater detail on one embodiment of the auction which is embedded directly into the VOD system. The VOD system 300 comprises a database 302 for storing the movie and ad assets. The stored movie asset 304 is presumed to have the appropriate avails marked 305. As indicated, the representation of an avail in the asset 304a is a logical representation, as the avail information is actually stored in the auction cache 306 as avail data associated with the program asset. The VOD system includes a Ad Decision Service (ADS) 310 (which may be embodied as separate units or functional units) that contains the logic for conducting the auction and which has access to the auction cache 306. The program asset is spooled out via connection 312 to the Video pump 320, where is it provided to the set top box over the cable network 322.

In the present embodiment, it is presumed the auction logic and rules are downloaded into the ADS using the appropriate infrastructure. In one embodiment, as the play of a VOD asset is initiated, the auction logic will process the avails in the movie asset and identify the potential advertisements in an auction cache or database 306. The database 306 stores meta-data about the digital advertisement asset, along with associated campaign data 308. This auction logic then ascertains which of the advertisements is eligible to bid for the avail associated with the movie, and determines a winner based on the rules defined, the campaign data, the selected movie asset and associated meta-data, and any other data (such as the demographics associated with the viewer selecting the movie).

The winning advertisement (in this case, Advertisement #2 305) is inserted into the movie asset stream 304b as it is spooled out to the Video Pump 320 where it is distributed over the cable network 322 to the set top box 324. In other embodiments, the advertisement assets may be stored in another database, and retrieved by the VOD system (or asset management system) as appropriate. Either approach is in accordance with the principles of the present invention.

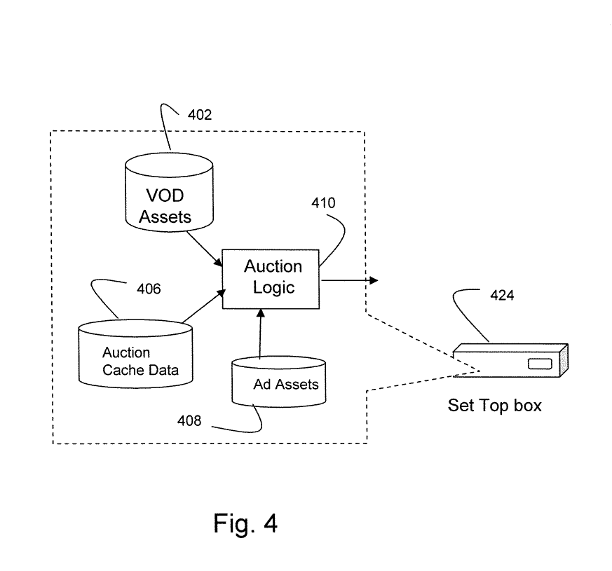

Alternative embodiments are possible. For example, as shown in FIG. 4, the auction could be performed in the set top box 424 itself. This would entail the set top box storing an auction cache 406, and possibly a library of available ad assets cached locally on the STB 408. Because advertisements are of limited duration, a number of advertisement assets can be downloaded to advanced set top boxes without occupying significant memory space. The advertisement assets are shown in a separate logical database 408, but they may be stored on a local hard drive in the set top box 424. The downloading of the advertisement assets and associated meta-data (as well as the other auction data) may occur when needed, or during ‘off’ hours, such as during early morning hours when the cable network is lightly loaded. The downloading may occur nightly, weekly, or according to coincide with the marketing programs of the advertisements. For DVR-enabled set top boxes, the VOD assets may also be stored on a local hard drive 402, but more likely, are downloaded only after selection by the viewers. They are stored with avails already defined (e.g., the avail data is included in the auction data). As the movie is being spooled out for viewing, the auction logic encounters the avail and conducts the auction among the ad assets to determine the winner. Upon selection, the ad is inserted for presentation to the viewer. Alternatively, all the avails can be auctioned and the entire playlist is determined before the program asset is spooled out.

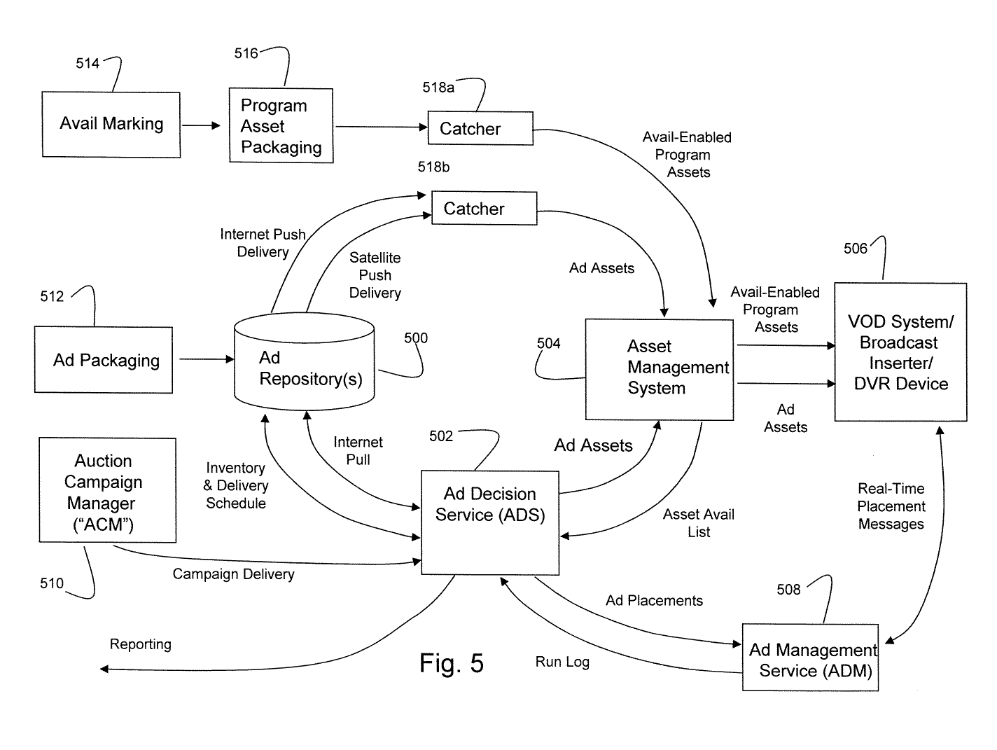

FIG. 5 illustrates other embodiments, which can be mapped on various network components. Not all the components are required, but are illustrated to show the flexibility in which the principles of the present invention can be applied. The ad repository 500 represents a database of ads. Although one is shown, several can be deployed in various locations in a cable network, and server to function to server different geographic areas or demographics. The ads in the database 500 are packaged offline 512.

The auction campaign manager 510 may be used to define auction logic that specifies either national or local scope of the viewing audience for an ad. It may allow the replacement of a national ad with a local ad downstream in the distribution process. The ACM also defines other criteria of an auction campaign, including how the ad is to be matched up with digital asset (e.g., a movie) and data pertaining to the bidding. For example, an ad could be defined to bid more for an opening avail (e.g., an avail at the beginning of a certain movie) than for an avail at the end of a movie. Alternatively, the auction campaign could bid more for an opening avail for a movie that is a comedy, than for a drama.

The Ad Decision Service ADS 502 interacts with one or more auction caches corresponding to one or more ACM for providing the auction information in various components. The ADS interacts with the Ad Management Service (ADM) 508, which receives real-time placement messages for avails to be filled by various components indicted 506, such as the VOD System, Broadcast Inserter, a digital video recorder (DVR) in the set top box, etc. Alternatively the auction cache may provide the auction logic/rules directly in various components indicated 506. When the component has completed the play of the movie and ads, it may report back to the ADS (via the ADM 508, or by other means), data regarding the auction, such as which ads were actually played and trick-mode activity. This allows the ADS to know which campaigns have completed, so that the results may be reported and analyzed.

The Ad Decision Service ADS 502 also interacts with the asset management system 504 that receives the ad and movie assets to determine of ad and movie inventory status. The asset management system can also provide the list of available avails in a program asset, so that the local auction campaign manager can define the ad campaign. The asset management system 504 provides the assets as needed to the various entities upon request. For example, since the system is constantly receiving new movies, they need to be received, the avails defined, and transferred to the appropriate VOD system.

The asset management system may receive programs from a catcher 518a that have already have avails enabled. These assets were previously packaged 516 and the avails marked 514. The asset manager system may also receive the ad assets from other components, such as the catcher 518b which can receive the ads using various technologies. In this manner, the asset management system can provide the ads to the components which stream the ad to the viewer, such as the VOD system 506.

The auctioning process requires an ad auction campaign to be defined. At a high level, for a given asset, such as a movie, there is a set of advertisements that are considered for each avail. The auction campaign may define certain rules and criteria which determine which advertisements are eligible to participate in the auction. For the perspective of an advertisement, each advertisement defines criteria regarding which movies assets it may be associated with.

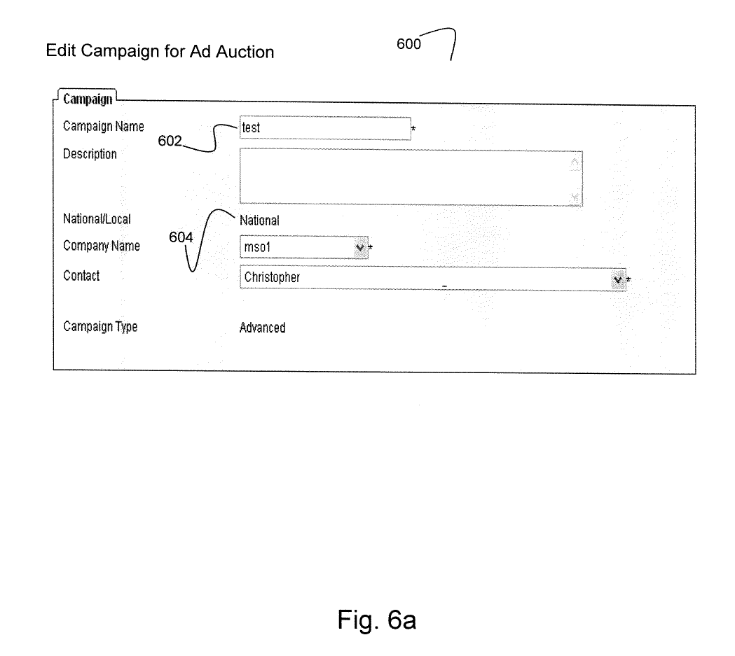

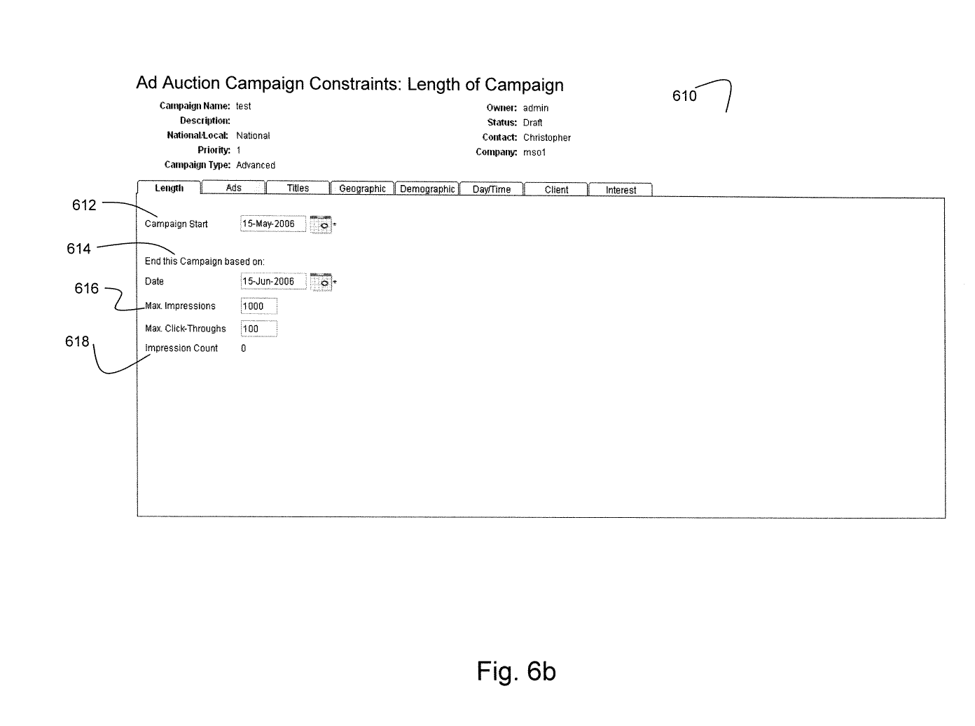

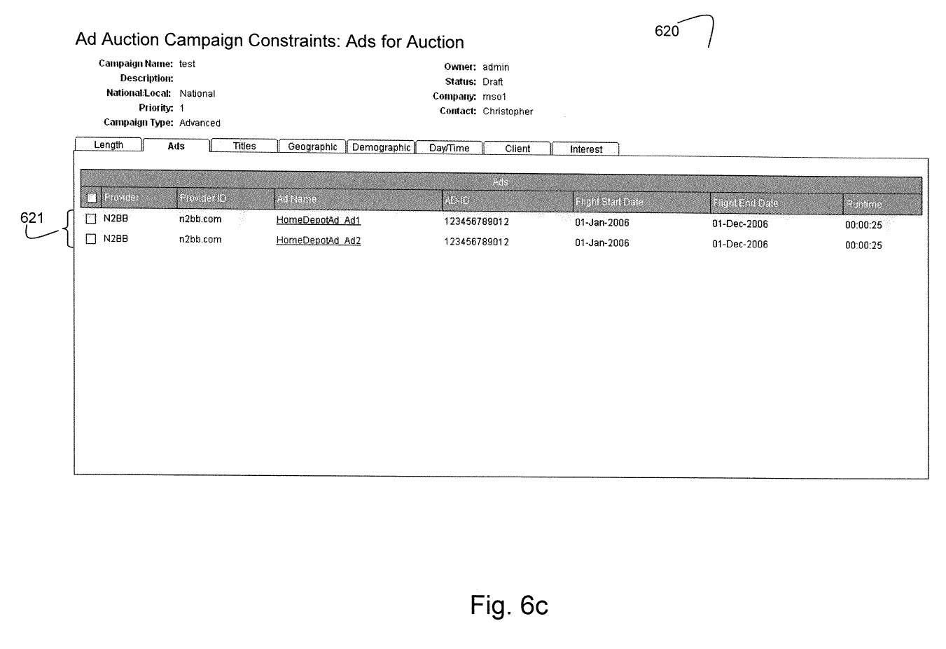

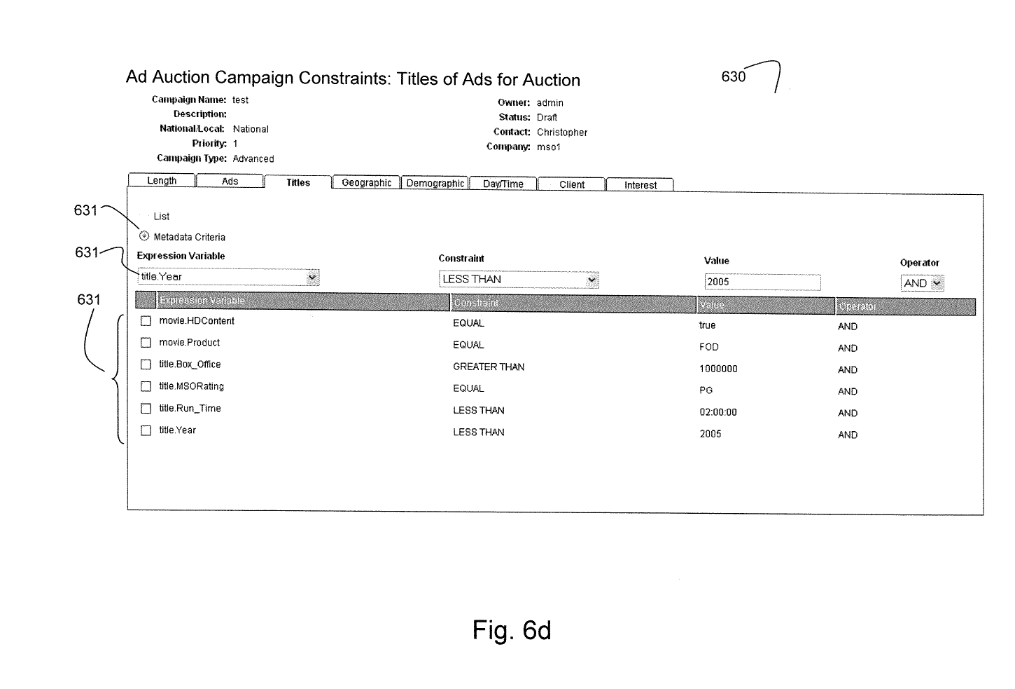

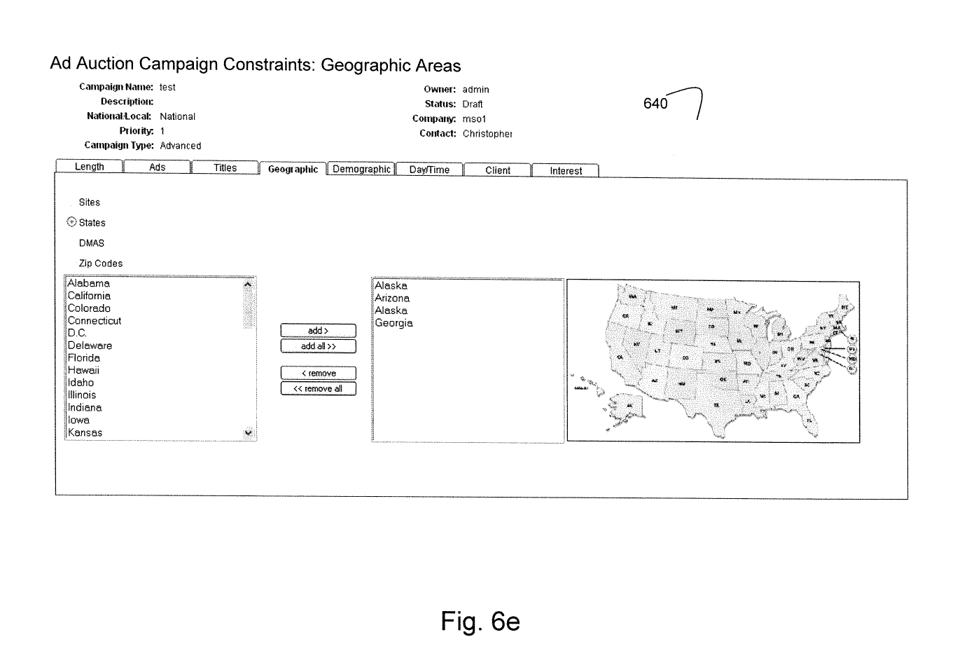

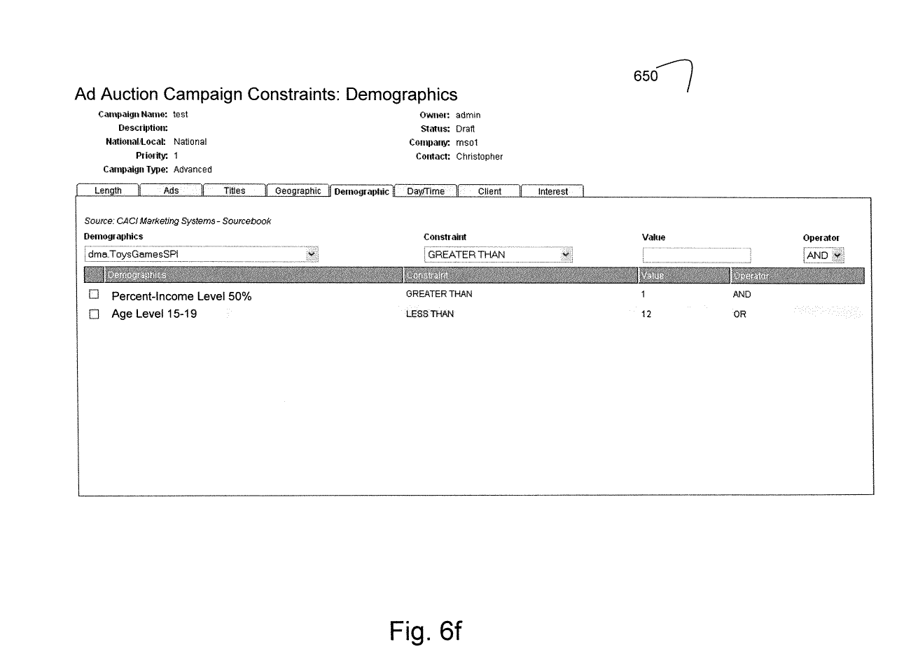

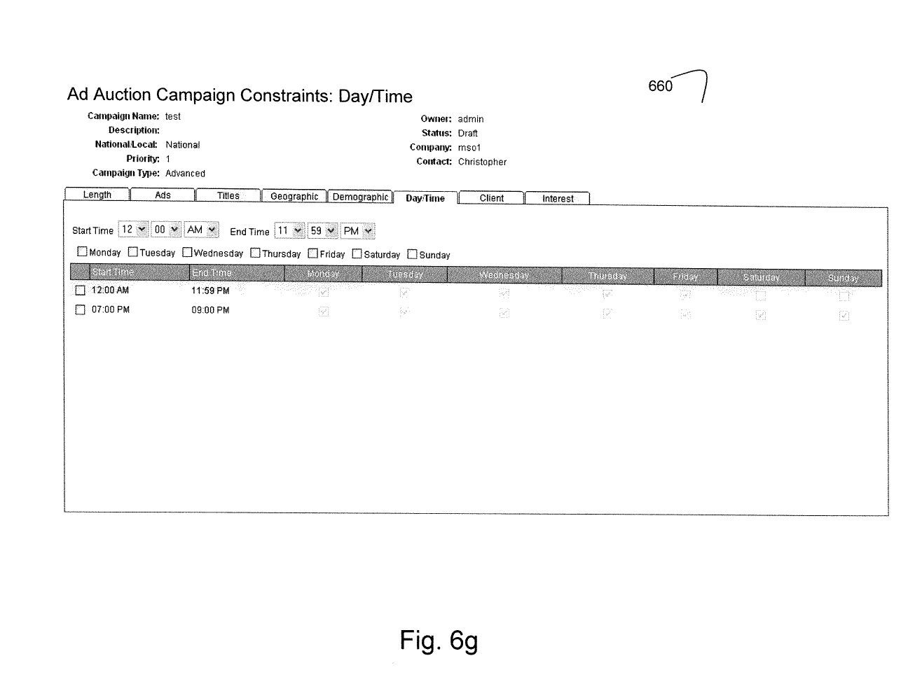

The establishment of the criteria is accomplished manually, by a user at a workstation (e.g., the auction campaign manager) defining the criteria. The FIGS. 6a-6g illustrate how that definition can be entered and created for an auction. In FIG. 6a, an initial screen 600 prompts a user to create a campaign by assigning it a name 602. By labeling a campaign with a name, it is easier for the user to refer to a campaign for referencing, editing, reporting, or other purposes. As it will be seen, a campaign can be stored, edited, and deleted. Other information may provide a company associated with the campaign 606 and whether it is local or national in scope 604. Other options include defining the campaign for a particular service (e.g., VOD) or local for a set top box, or group of set top boxes.

Turning to FIG. 6b, the next screen 610 allows the user to define when an auction campaign occurs. This is indicated by providing a start date 610 and end date 614. Alternatively, a maximum number of impressions (e.g., presentations of the ad to viewers) may be the limit. This value can be indicated 616. The auction campaign manager can also report during a campaign, or after it has completed, how many impressions of various ads were actually counted 618. If the count is reached before the end of the campaign, one option may be to consider the auction complete.

Next, in FIG. 6c, another window is presented to the user to define the set of potential ads that may be considered in the action process. In the embodiment illustrated, two ads 612 are presented. The ads themselves have are identified by various names, sources, identifiers, and other information such as available dates, and runtimes.

Next, in FIG. 6d, the ads are associated with various movie programs, or titles. The screen 630 provided to the user allows metadata criteria 631 of the movie assets that can be qualified for association with the movie asset. Each movie is associated with various meta-data 633 specifying the subject matter, title, rating, etc. For each parameter, criteria can be defined specifying eligibility of whether the ad is appropriate to be considered for bidding of the movie. For example, in the present ad campaign, the ads are associated with movie assets where the movie is less (e.g., older) than 2005 (see line 632). Thus, the ads will only be associated with movies 2005 or older. This criterion can be logically coupled with other criteria, such as movies having only a certain rating (e.g., “PG”).

Next, the campaign manager allows the user to specify a geographic area in which the ads may be viewed. Turning to FIG. 6e, means are presented for the user 640 to select the states or regions in which an ad may be presented. Other geographic distributions are possible, such as cities or other serving areas. By selecting the appropriate areas, additional criteria is defined for the campaign.

Next, turning to FIG. 6f, the user is presented with a screen 650 which allows selection of various demographics related factors. For example, the user can opt to have the ad presented to viewers of a certain average income level, age group, ethnic group, etc. The users may be able to construct logical constraints for how the ad should be correlated, including minimal ages, income levels, etc.

Finally, turning to FIG. 6g, the user is presented a screen 660 with time constraints that they can associate the ads with. This includes defining certain time windows in which the ad can be presented.

Auction Process

The various previous screens allow the ads to be associated with various movies in various ways. Thus, a set of ads can be associated with a specific movie, targeted to a certain geographical area, targeted to a certain demographic group, targeted within a certain time period, and targeted during certain times of the day. In addition, other combinations are possible. Those ads which are compatible or eligible can then bid for avail associated with the program asset. The auction logic determines the winners and their order for insertion into the movie asset upon playback. It is thus quite likely that a viewer selecting the same movie on consecutive days would encounter different ads inserted into the selected movie.

The auction process for the avails in a program asset can occur all at once, or sequentially in time. If they occur all at once, then the auction occurs for all the avails in the asset and the asset is played out to the viewer with the VOD system aware of the entire playlist of commercials. In other embodiments, the VOD system may signal for a separate auction for each avail in real time, as the movie is being spooled out and the avail point in the movie is reached. The auction scheme may be dependent on the capabilities of the various pieces of equipment that are involved in the auction, such as the Video Pump.

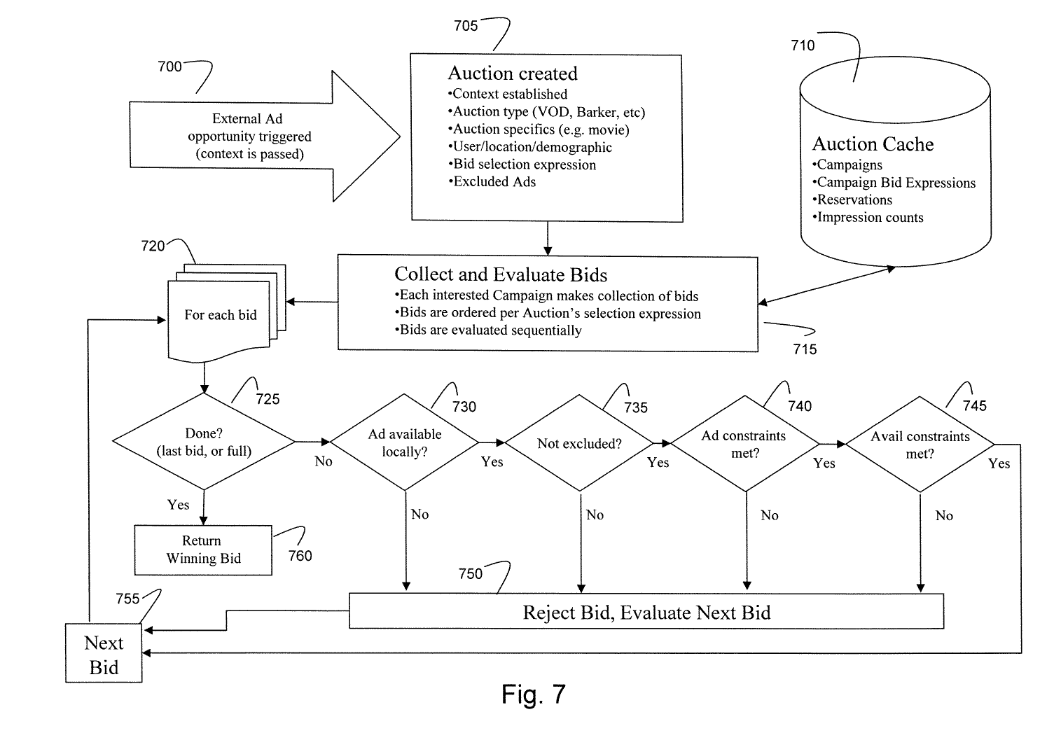

Turning to FIG. 7, the auction process is depicted. This is predicated on all the avails in the selected program asset being allocated in a single auction. However, the process can be readily adapted to a sequential auction format. The process starts in step 700 where an external opportunity for an action is triggered. In the embodiment described, this would be the user selecting a movie from a movie on demand service. The reception of the request by the cable network would trigger the auction.

The next step, step 705 is establishing the auction. The creation of an auction requires context (“auction context”) to be established. The context of the auction can comprise several criteria. First, the auction type must be determined. In this case, it is a VOD auction, which may have a different set of rules than other auction formats (e.g., a format selected for a barker channel). The context must also ascertain the program asset (movie) type (comedy, drama, mystery, etc.) and the title of movie. In addition, the user's demographics and location must be ascertained. Thus, any data necessary to evaluate the campaign related auction data is ascertained.

Another potential aspect of the auction context is the determination of the type of viewing device involved. The type of device may impact the advertisement asset selected. For example, certain ads may be in high-definition digital video, so that they may not be eligible for selection if the user is using a standard definition viewing device. Or, the user may have a mobile video device (e.g., a cell phone or other portable device) such that certain ads may not be as effective on a small screen (e.g., they may comprise text, which is not likely to be comprehensible by the viewer on a small display screen). The auction logic defines whether this is an important criteria in processing the selection of the advertisements. The viewing device may comprise both the STB and the display device, as the capabilities of the viewing device may be the result of the combination, or interaction of, the STB and the display device. As noted previously, the functionality of the STB may be embodied in various devices other than a traditional set top box.

The auction context may also define restrictions or exclusions. In some cases, a particular avail may be excluded from an auction. An avail may have been previously allocated to an advertisement. Effectively, the avail is no longer eligible for an auction. In such instances, the avail is said to have been reserved. Furthermore, similar to auctions of goods, an avail may have a ‘reserve’ amount defined where the avail will go to a defined ad if the bidding does not meet a certain level. Also, an avail may be defined to exclude certain ads from bidding (or winning a bid). For example, a cable service provider, broadcaster, or other entity distributing a movie may define that certain ads should not be shown with the movie. For example, an ad for an airline may be defined as being eligible for movies of a “PG” nature. However, a campaign may exclude placing the same airline ad in a “PG” rated movie depicting an airline disaster because doing so might not leave a favorable image of the airline with the viewer.

Next, step 715 collects and evaluates the bids. To do so, the auction campaign data 710 in the auction cache must be retrieved. The auction campaign data is the set of information that is used to marry the advertisements to the program assets, in the auction context. The auction campaign data comprises the data formed during the user's input as discussed in FIGS. 6a-6g. Given the context of the auction, the appropriate auction cache data can be retrieved, including the campaign data, reservation data which would impact the priority of certain bidders, the bid expressions used for evaluating the bids, and finally the impression related data.

The impression related data (or simply ‘impression data’) includes various information about the history of asset and advertisement viewings, which may impact the selection of the advertising asset. It may comprise information about the particular viewer that the advertisement was shown to, when it was shown, what avail for which program asset the advertisement was selected for, and how many times it was previously selected. The purpose is to collect and make this data available for purposes of using it as input to the auction process in determining whether the advertisement should be selected again. For example, the advertisement asset may have a total count value indicating how many times a given ad has been selected. Since an ad or campaign may have a limit on the number of impressions provided during a campaign, this data indicates the current number of times the advertisement has been selected, and whether the limit has been reached. If so, that advertising asset may be eliminated from bidding. The auction may also opt to not select advertisements which were recently shown to a user to be selected again, even thought the bid associated with the advertisement may otherwise have won the auction. Thus, the last time that the viewer was presented with the advertisement may impact the selection of the ad. This avoids presenting the same advertisement to the viewer too often or too frequently. Thus, one criteria of the auction logic may be that any advertisement shown the user in the past 24 hours should not be shown again within that timeframe. Another criteria may be that if the same advertisement may not be selected for the same digital program asset, e.g., it may be selected only once per viewing of a movie. The auction logic can be varied, and can be defined separate for each respective campaign auction.

Once all the auction data is obtained, each bid for an avail can be auctioned and analyzed. In FIG. 7, this occurs by first determining whether the auction is completed in step 725. If not, then the next step is to determine whether the advertisement is available 730 for selection. If for some reason, an ad asset is not available, then it should be excluded. This may occur if the advertising asset itself was not loaded into the appropriate database. If so, then it would not available for insertion into the movie. This type of validation can avoid an auction result which awards an ad placement which can not be fulfilled by the video pump and thus the loss of the avail opportunity. Next, the ad is evaluated in step 735 as to whether it should be excluded for some reason. Certain ads may be excluded from selection for during certain times of day, in conjunction with certain programs, etc. If the ad is eligible, then the next step in step 740 is to determine if the ad constraints are met. These include the constraints that were previously created as discussed in conjunction with FIGS. 6a-6g. Assuming that these constraints are met, the constraints with the avail are examined in step 745. This may include, for example, the time duration indicated as allowable for the avail. Thus, if the avail indicates that a maximum of 30 seconds of advertising can be inserted, a 60 second ad would be not be eligible.

Either the bids are rejected as shown in step 750 or they are not. The process continues with the next bid 755 until all the bids are completed. If completed in step 725, the winning bids are returned in step 760.

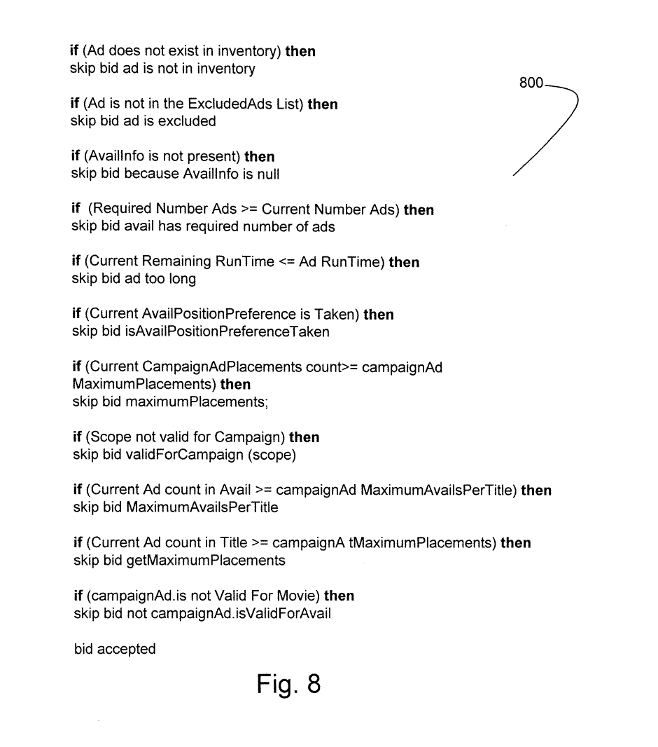

An example of the logic used in evaluating a bid is shown in FIG. 8, and includes various tests to determine if the ad is eligible, or if the testing of other exception conditions precludes consideration of the ad. These tests are illustrative, and other embodiments may test for other conditions or exceptions. As evident, various exceptional conditions are tested, to see if the ad can even be considered. For example, if the ad does not exist, the avail is missing necessary data, if the number of ads exceeds a limit, or if the time constraints prohibit such, then the ad may not be considered an eligible bidder.

A traditional auction typically only allows pre-qualified entities to make a bid, and the winner is determined by the highest resource bid (e.g., money) offered. In the present context, the resource could be a priority level, a value representing money, or some other finite resource. In this context, the highest resource bidder would be associated with the avail (e.g., win the bid) whereas in other auction formats, a group of avails may be auctioned. Once the avail is ‘won’ by an advertisement and the ad is shown to the viewer, the impression count associated with the advertisement (and its available resources for future bidding) would be incremented.

In one embodiment, there is no ‘resource’ involved by the competing ads. Essentially, this is analogous to an “auction” where individuals simply indicate they are interested in the item being auctioned, and all indicating such are tied as winners. Obviously, the question is how to resolve the tie. In one embodiment, the auction logic simply selects the ad having the lowest number of impressions to date. The lowest number of impressions may be an absolute number (only 10 impressions provided to date) or the lowest ratio (e.g., only 10 impressions of 1000 or 1% to date). The auction logic essentially determines the winner by selecting among the eligible ads, which one win, which decreases the ads chances for being tied in the next auction. If there is a subset that has the same impression count (essentially resulting in another tie), the system could select one at random.

For example, consider three bids for ads: Ad #1, Ad #2, and Ad #3. The auction processor may determine that two of the three are available, eligible, and meet the constraints. In this sense, these two ads (assume Ad #2 and Ad #3) “tie”. The system elects the ad with the lowest impression count to select the winning ad—Ad #3. For the next auction, assuming again that Ad#2 and Ad#3 are available and eligible, they would again result in a “tie.” The tie-breaker involves examining the impression count, which would presumably result in Ad #2 being selected this time.

Of course, an explicit bidding resource (such as a value corresponding to a currency) could be defined for selecting the winner. The interaction between the impression count and the resource level would have to be resolved since it is possible to exhaust the maximum number of resources earlier or later, relative to the bidding resource. However, this would allow an advertiser to increase the likelihood of obtaining a desired advertising spot. This may result in the ad exhausting its resources and being selected for the less desirable avails. Alternatively, if an advertisement is to be definitely associated with the avail, the ad could be ‘reserved’ for use with the avail, essentially removing the avail from the auction process.

As with regular auctions, many variations on the auction process can occur. The concept of a ‘reverse’ auction can be defined where a descending bid value is lowered until a bidder accepts it. Alternatively, a Dutch auction can occur a group of avails are bundled for auction. The application of various types of auction formats is within the scope of the present invention. Further, different auction formats can occur in different components or in different advertisement contexts. For example, an ADS and VOD system may implement a certain format where demographics are considered as part of the criteria. A barker advertisement (this is the advertisement that appears in a portion of the screen when viewing a program guide channel displaying the channels and associated programs on the other portion of the screen) may have a different auction format, and may exclude demographics (since it would be provided to a wider audience). Rather, the barker channel may focus on weighting a particular metric (e.g., time of day). Another example of a different auction format is that the barker channel may only show very short duration advertisements. Since the viewer typically views the barker channel only to ascertain the program listings, shorter ads may be more appropriate. Thus, the auction format for the barker channel may have constraints not present in other auctions.

Thus, various constraints may be defined by the auction format in addition to the constraints associated with program asset, the constraints associated with the advertising asset, and the advertising campaign. Not all auctions necessarily have to use the same type of criteria in each case.

The results of the auction may be reported back to the campaign manager so that the results may be reported and analyzed. The main metric involved is ascertaining the impressions associated with an advertisement. Since a campaign is of a limited duration, it is usually of interest to the advertiser when and how many times the advertisement was selected during the campaign. Further, it is in the cable provider's interest to be able to verify to the advertiser when the ad was selected and that the number of contracted impressions actually occurred.

As disclosed above, the embodiments for implementing the advertisement auction capability vary, and can occur in various elements. The rules and format of the auction can vary, as can the actual bidding process. The present invention is only limited as expressly indicated in the claims presented below.

That which is claimed:

1. A system for auctioning advertisements in a video distribution system comprising: an auction cache comprising:
(1) advertisement auction campaign data defining attributes of an advertising campaign including a time duration of the advertisement auction campaign,
(2) a plurality of advertisement data associated with a plurality of digital advertising assets, wherein each advertisement data comprises:
(a) a set of advertising meta-data indicating criteria for selecting the respective digital advertising asset, and
(b) impression data, and
(3) digital video asset meta-data associated with a digital video asset, the digital video asset meta-data comprising data indicating a plurality of avails associated with the digital video asset;
an auctioning processor configured for receiving an indication triggering execution of an auction program in a context associated with the digital video asset, the auctioning processor processing each of advertisement data with respect to both the advertisement auction campaign data and the digital video asset meta-data so as to ascertain a respectively selected digital advertisement asset for one of the pluralities of avails; and
a video source providing the digital video asset and the plurality of respectively selected digital advertisement assets for presentation to a viewer of the cable distribution system.

2. The system of claim 1, wherein the video source comprises a first video source providing the digital video asset and a second video source providing the digital advertising assets.

3. The system of claim 1, wherein the video source is a video pump receiving the digital video asset from a video-on-demand system.

4. The system of claim 1, wherein the digital video asset comprises a digital movie asset and the digital video asset meta data further comprises a title of the digital movie asset and a rating indication associated with the digital movie asset.

5. The system of claim 1, further comprising:
a database storing the plurality of digital advertising assets from which the selected digital advertisements are retrieved and provided to the video source.

6. The system of claim 1, further comprising a video-on-demand system comprising the advertising auction campaign data, the auctioning processor and the video sources.

7. The system of claim 6, wherein the video-on-demand system comprises a database storing the digital program asset.

8. The system of claim 1, further comprising a customer based device comprising the advertising auction campaign data, the auctioning processor and the video source.

9. The system of claim 8, wherein the customer based device is a set top box.

10. The system of claim 1, wherein the respective selected digital advertisement asset associated with each one of the plurality of avails has a respective impression count less than a respective maximum impression count.

11. The system of claim 1, wherein the auctioning processor receives the indication of the digital video asset in response to a viewer selecting a movie associated with a video on demand service thereby triggering the execution of the auction program.

12. The system of claim 11, wherein the auctioning processor further processes each of advertisement data with respect to both the campaign data to and the digital video asset meta-data using demographic data associated with the viewer so as to ascertain an eligible advertisement.

13. The system of claim 1, wherein the auctioning processor further processes each of the advertisement data with respect to the campaign data and the digital video asset meta data by evaluating a plurality of bids in order to ascertain the selected digital advertising asset.

14. The system of claim 12, wherein the auctioning processor ascertains the eligible digital advertisement asset based on the type of viewing device being used by the viewer.

15. The system of claim 14, wherein the eligible advertisement is a standard or high definition digital advertisement asset and the auction processor ascertains the eligible digital advertisements asset based on the viewing device.

16. The system of claim 1, wherein a database maintains historical impression data.

17. The system of claim 1, further comprising an advertisement campaign manager connected to the auction cache, wherein the advertisement campaign manager provides the advertisement auction campaign data, the plurality of advertisement data, and the digital video asset meta-data to the auction cache.

18. A method of selecting a digital advertisement asset for presentation to a viewer in a digital video asset distribution system comprising the steps of:
storing avail-related data associated with a digital video asset, wherein the avail-related data indicates the provision of one of a plurality of digital advertising assets when spooling the digital video asset to the viewer;
storing auction cache data comprising:
(1) a plurality of advertisement data wherein each advertisement data comprises advertisement meta-data and associated impression data comprising an impression count,
(2) digital video asset meta-data comprising avail related characteristics for the digital video asset, and
(3) advertising auction campaign data defining attributes of an auction advertising campaign involving the plurality of advertisement data;
creating an auction context involving the digital video asset;
processing the digital asset meta-data, the plurality of advertisement data, and the auction campaign data in order to identify a digital advertising asset associated with one of the plurality of advertisement data; and
spooling the first digital video asset and the digital advertising asset to a viewer.

19. The method of claim 18, wherein the creating of the auction context is triggered by a user selecting the digital video asset for viewing in conjunction with a video-on-demand service.

20. The method of claim 18, wherein the processing of the digital asset meta-data and the auction campaign data occurs in a video-on-demand system or in a set top box.

21. The method of claim 18, wherein the identified digital advertising asset is retrieved from a database storing the plurality of digital advertising assets.

22. The method of claim 18, wherein the avail-related data of the digital video asset is created on an editing workstation prior to the step of storing.

23. The method of claim 18, wherein the impression data associated with the identified digital advertising asset is updated upon spooling of the digital advertising asset to the viewer.

24. The method of claim 18, where the identified digital advertising asset is associated with a viewer selecting the digital video asset within a geographical area location indicated by the auction campaign data.

25. The method of claim 18, where the identified digital advertising asset is associated with a demographic metric associated with the viewer initiating a request to view the digital program asset.

26. The method of claim 18, where the identified digital advertising asset is selected in part by analyzing the impression data associated with the identified digital advertising asset.

27. A method of preparing a digital advertising asset for an advertising auction comprising:
receiving a digital program asset;
defining a plurality of avails associated with the digital program asset;
storing a plurality of data in an auction cache comprising:
(1) auction advertising campaign data including a duration of the campaign,
(2) program meta-data associated with a digital program asset,
(3) a plurality of advertising meta-data associated with a plurality of digital advertising assets, each advertising meta-data including a demographic criteria of a target audience, and
(4) demographic data associated with a viewer;
transmitting the digital program asset to a video on demand system;
receiving a viewing request at the video on demand system for the digital program asset from the viewer;
retrieving the demographic data associated with the viewer;
the video-on-demand system processing the plurality of avails of the digital program asset to identify a respective digital advertising asset associated with each avail of the digital program asset, wherein each digital advertising asset is associated with the respective avail by determining the demographic criteria of the respective advertising meta-data associated with the digital advertising asset is compatible with both the demographic data associated with the viewer and the rating of the program meta-data; and
spooling the digital program asset with the plurality of digital advertising assets to the viewer.

28. The method of claim 27, wherein the processing of the plurality of avails comprises executing an auction process for each avail by evaluating respective bids from each of the plurality of auction advertising campaigns.
